(19) United States
(12) Patent Application Publication
(10) Pub. No.: US 2014/0074623 A1
(43) Pub. Date: Mar. 13, 2014

(54) TARGETED MESSAGING

(71) Applicant: BCE INC., Verdun (CA)

(72) Inventors: Elnaz MOHAMMADI, Toronto (CA); Jefferson OR, Markham (CA); Bob ROGERS, Toronto (CA)

(73) Assignee: BCE INC., Verdun (CA)

(21) Appl. No.: 14/022,839

(22) Filed: Sep. 10, 2013

Related U.S. Application Data
(60) Provisional application No. 61/698,991, filed on Sep. 10, 2012.

(51) Int. Cl. G06Q 30/02

(52) U.S. Cl. CPC G06Q 30/0269
USPC 705/14.66

(57) ABSTRACT

A method, computer apparatus and non-transitory computer-readable storage medium implementing a method for sending targeted promotional messages to subscribers to a telecommunications service for execution by at least one network element of a service provider. The at least one network component determines profiling criteria and an advertisement timing associated with an advertising campaign. The at least one network component consults a context awareness engine that stores time-varying user data for a plurality of subscribers. At a time which satisfies the advertisement timing, the at least one network component sends a message to a subscriber whose user data match the profiling criteria. The at least one network component repeats the steps of consulting and sending after a change in the user data has occurred during the advertising campaign.

### CROSS-REFERENCE TO RELATED APPLICATION

The present application claims the benefit under 35 USC §119(e) of U.S. Provisional Patent Application Ser. No. 61/698,991, filed Sep. 10, 2012, hereby incorporated by reference herein.

### BACKGROUND

The world of advertising changed forever with the arrival of ubiquitous data-connected mobile phones (smartphones) and tablets. From the moment advertisers has access to the locations of their potential customers, the race to convert mobile users to customers began. For example, if the location of a particular mobile device is known, advertisements can be made to appear which promote nearby stores or restaurants, in the hopes of capitalizing on the subscriber's impulsive reaction to shop or eat. However, as the volume of advertisements grows, there is a risk of rendering subscribers indifferent to advertisements being sent to their mobile devices. Thus, the ability to discriminate between ads to send and ads not to send becomes an industry differentiator.

### SUMMARY

A first broad aspect of the present invention seeks to provide a method for execution by at least one network element of a service provider, the method comprising the step of determining profiling criteria and an advertisement timing associated with an advertising campaign. The method further comprises the step of consulting a context awareness engine that stores time-varying user data for a plurality of subscribers. The method still further comprises the step of, at a time that satisfies the advertisement timing, sending a message to a subscriber whose user data match the profiling criteria. The method further still comprises repeating the aforementioned steps of consulting and sending after a change in the user data has occurred during the advertising campaign.

A second broad aspect of the present invention seeks to provide a computing apparatus comprising an I/O, a memory and a processing engine, the processing engine executing computer-readable instructions stored in the memory. Said processing engine executes said computer-readable instructions stored in said memory for determining profiling criteria and an advertisement timing associated with an advertising campaign. Said processing engine executes said computer-readable instructions stored in said memory further for consulting a context awareness engine that stores time-varying user data for a plurality of subscribers. Said processing engine executes said computer-readable instructions stored in said memory still further for, at a time that satisfies the advertisement timing, sending a message to a subscriber whose user data match the profiling criteria. Said processing engine executes said computer-readable instructions stored in said memory still further for repeating the aforementioned steps of consulting and sending after a change in the user data has occurred during the advertising campaign.

A third broad aspect of the present invention seeks to provide a non-transitory computer-readable medium comprising computer-readable instructions which, when executed by a computing hardware, cause the computing hardware to execute a method, the method comprising the step of determining profiling criteria and an advertisement timing associated with an advertising campaign. The method further comprises the step of consulting a context awareness engine that stores time-varying user data for a plurality of subscribers. The method still further comprises the step of, at a time that satisfies the advertisement timing, sending a message to a subscriber whose user data match the profiling criteria. The method further still comprises repeating the aforementioned steps of consulting and sending after a change in the user data has occurred during the advertising campaign.

A fourth broad aspect of the present invention seeks to provide a method, the method comprising the step of providing a telecommunications service to a plurality of subscribers. The method further comprises the step of querying a context awareness engine to identify a subset of the subscribers having opted in to a targeted promotional messaging service. The method still further comprises the step of sending a targeted promotional message to the subscribers in the subset to promote a product or service and refraining from sending the targeted promotional message to those subscribers who are not in the subset.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a functional block diagram of a network architecture implementing the targeted messaging service.

FIG. 2 is a flowchart illustrating an embodiment of a mobile API.

FIGS. 3-5 are conceptual block diagrams illustrating functionality implemented by a Context Aware Engine.

FIG. 6 is a conceptual block diagram of a flowchart illustrating a process that may be carried out by a targeted messaging system.

FIG. 7 is a conceptual block diagram of a subscriber database maintained by a service provider.

FIG. 8 is conceptual block diagram of a advertising campaign database maintained by an advertiser.

FIG. 9 is a functional block diagram illustrating functionality of a Data Gathering functional module.

It is to be expressly understood that the description and drawings are only for the purpose of illustration of certain embodiments of the invention and are an aid for understanding. They are not intended to be a definition of the limits of the invention.

### DETAILED DESCRIPTION

Described herein is a system that allows advertisers and advertising networks to partner with a service provider or home mobile network operator (MNO) and target groups of subscribers through a variety of channels, such as SMS, MMS, email and social networking. While the messaging system can initially allow for the targeting of the home MNO's subscribers, the system can be scalable to add additional (non-home) MNOs at a later date.

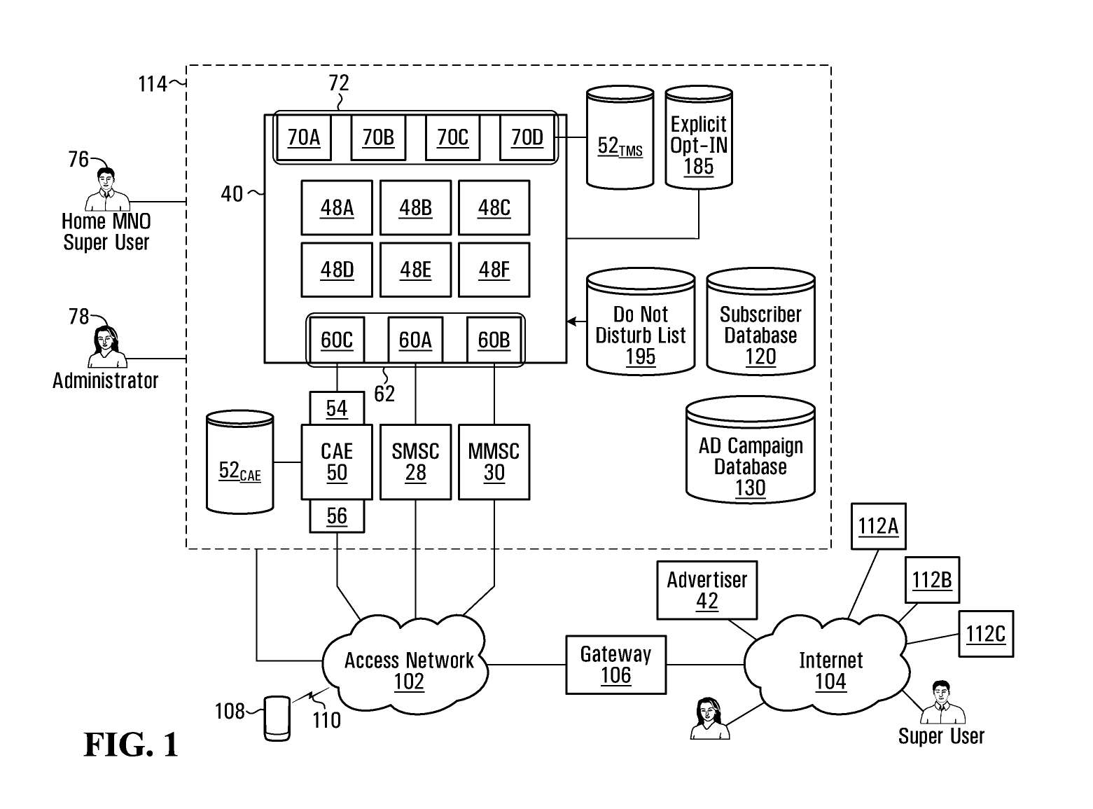

Reference is made to FIG. 1, depicting a functional block diagram of a network architecture in which a service provider delivers a targeted messaging service to part of its overall subscriber base, in accordance with specific non-limiting embodiments of the present invention. Generally speaking, the service provider's subscriber base comprises a plurality of subscribers that hold respective accounts with the service provider. Each subscriber account is registered to a customer and is associated with a specific user device and/or physical link and/or geographic location. To simplify the present description, the remainder of the embodiments being considered will assume that subscriber accounts are associated with specific user devices, such as mobile devices, including a user device 108. However, it should be appreciated that this does not limit the scope of the present invention, which also applies to the case where subscriber accounts are associated with specific physical links and/or geographic locations and/or other criteria.

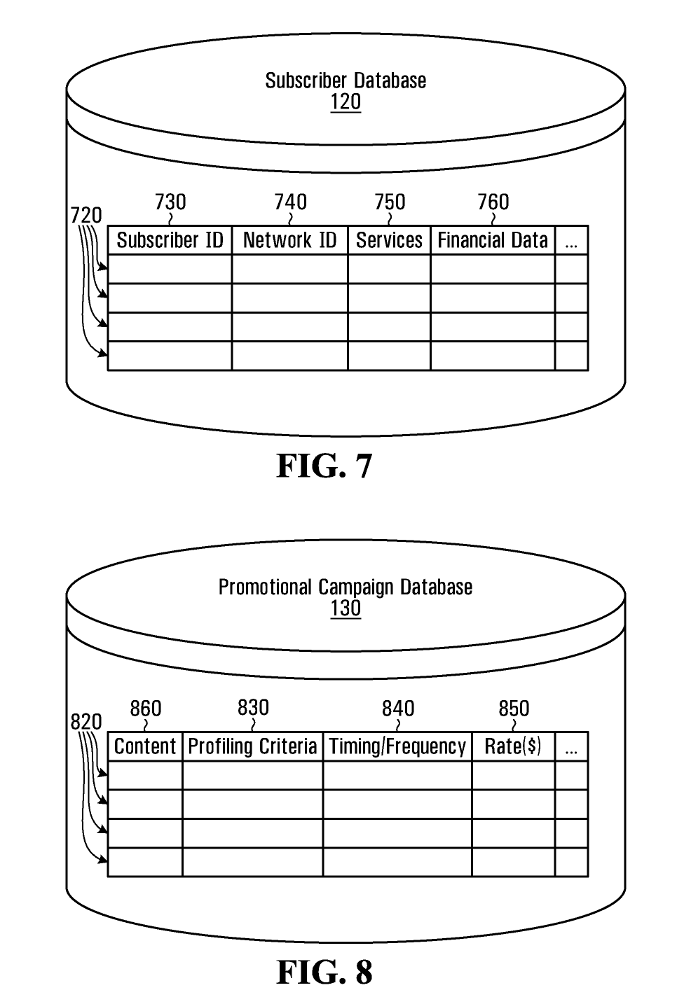

Account information for the various subscribers may be held in a subscriber database 120 or other memory system maintained by the service provider. FIG. 7 shows a non-limiting configuration of the subscriber database 120 in accordance with a specific non-limiting embodiment of the present invention. The subscriber database 120 may be tangibly stored in a memory medium. For the purposes of simplifying the present description, the subscriber database 120 is conceptually illustrated as a table comprising a plurality of rows 720, each of which pertains to a particular subscriber. Each row includes a “subscriber ID” field 730, a “network ID” field 740, a “services” field 750 and a “financial data” field 760.

The “subscriber ID” field 730 in a given row may include information that uniquely identifies a particular subscriber. This may include the name, address or other identifier of an individual or company.

The “network ID” field 740 in the row corresponding to a particular subscriber may include an identifier of a user device registered to that subscriber. For example, where the user device is a mobile phone, the “network ID” field 740 may store a serial number of the mobile phone. In another example, the “network ID” field may 740 store a telephone number assigned to the mobile phone. In yet another example, the “network ID” field 740 may store an IP address of a device registered to the subscriber. It should be appreciated that more than one user device may be registered to a particular subscriber, and therefore more than one of the rows 720 may be associated with the particular subscriber.

The “services” field 750 in the row corresponding to a particular subscriber includes a list of services (such as telecommunications services) that are available to that subscriber. Examples of services can include the ability to place or receive voice calls (including features such as call waiting, call display, etc.), the ability to transmit or receive text messages, instant messages or MMS messages, the ability to watch television and/or movies on the user device 108, the ability to access network-based PVR services (e.g., television show recording), the ability to play online games (including video games and gambling), the ability to access the Internet, in addition to possibly other services.

The “financial data” field 760 in the row corresponding to a particular subscriber includes information that can be used to charge the subscriber. For example, this may include banking information and/or credit card information from which monthly debits are made. If the billing method is invoicing, then the “financial data” 760 field may be empty or it may include a billing address of the subscriber. Other fields may also be included in each row 720.

### Network Architecture

With continued reference to FIG. 1, the network architecture includes an access network 102 connected to a data network 104 via a gateway 106. The access network 102 can comprise an arrangement of routers, switches, multiplexers, base stations, base station controllers and/or other equipment. In a non-limiting embodiment, the data network 104 may comprise a section of the global network of interconnected computers and domain name servers known as the Internet. A large number of computers, known as websites, are connected to the Internet, and each is associated with an IP address where that website can be reached, as well as a unique alphanumeric name. FIG. 1 shows three websites 112A, 1128, 112C by way of non-limiting example.

The access network 102 allows the delivery of telecommunications services to user devices. An example user device is indicated at 108. In this example, the user device 108 is a mobile device (such as a smartphone, tablet, featurephone, dumbphone, data stick, etc.), which communicates with the access network 102 over a wireless link 110 using a wireless communications protocol. Other user devices connected to the access network 102 need not be mobile devices. For example they may be home gateways, set-top boxes, computers, game consoles or other equipment. The user device 108 may also be equipped with wireless local area network (WLAN) functionality, allowing it to communicate with, for example, third-party hotspots while bypassing the access network 102.

The equipment in the access network 102 is controlled by a service provider control network 114. The service provider control network 114 comprises one or more computing entities (e.g., computers, mainframes, servers) that are under the control of a commercial entity known as a service provider. The service provider has a relationship with a plurality of subscribers. A subscriber can be viewed as an entity (e.g., a person or company) having an account to which is registered a user device or a plurality of user devices. The subscriber is charged (on a post-paid or pre-paid basis) by the service provider for services (such as telecommunications services) that are made available to its registered user device(s) when it(they) is(are) connected to the access network 102. In some embodiments, the service provider may be a mobile network operator (MNO), while in other embodiments, the service provider may be an Internet Service Provider (ISP).

Additionally, the service provider control network 114 may include or be connected to an SMSC (short message service center) 28 and an MMSC (multimedia messaging service center) 30, which can be used for the delivery of mobile-originated and mobile-terminated SMS and MMS messages, respectively.

The SMSC 28 can be a physical network component that executes plurality of tasks, which may include:
Reception of text messages (SMS) from wireless network users
Storage of text messages
Forwarding of text messages
Delivery of text messages (SMS) to wireless network users
Maintenance of unique time stamps in text messages

In the case of an MMSC 30, this may be a physical network component that executes a plurality of tasks. For example, the MMSC receives MMS messages containing encoded multimedia content. Once the MMSC has received a message, it first determines whether the receiver's handset is “MMS capable”, i.e., that it supports the standards for receiving MMS. If so, the content is extracted and sent to a temporary storage server with an HTTP front-end. An SMS “control message” containing the URL of the content can then be sent to the recipient's handset to trigger the receiver's WAP browser to open and receive the content from the embedded URL. Several other messages may be exchanged to indicate status of the delivery attempt. Before delivering content, some MMSCs may also provide a conversion service that will attempt to modify the multimedia content into a format suitable for the receiver. This is known as “content adaptation”. If the MMSC determines that the receiver's handset is not MMS capable, the MMSC may notify the message sender that the MMS message was undeliverable, notify the receiver that an MMS message was undeliverable, discard the message or take any other appropriate action.

The service provider control network 114 can further include a targeted messaging system 40 and a context awareness engine (CAE) 50, both of which will be described in further detail below.

### Advertising Campaign

In some embodiments of the present invention, an advertiser 42 sets up an advertising campaign, which can also be referred to as a promotional exercise, a marketing effort, etc. The targeted messaging system 40 carries out the advertising campaign for the advertiser 42 by sending specific advertising messages to specific subscribers at specific times.

The advertising campaign may serve to promote one or more products or services to individuals having a certain “profile” which can be defined in terms of demographics and/or subscriber interests. The advertising campaign may define the terms under which the service provider will promote its products or services to its subscribers, as well as the fee that will be paid to the service provider for doing so. For example, the advertising campaign may be defined by parameters stored in an advertising campaign database 130. The advertising campaign database 130 may be tangibly stored in a memory medium.

With reference to FIG. 8, the advertising campaign database 130 is conceptually shown as a table comprising a plurality of rows 820, each associated with an advertising campaign set up by a particular advertiser. The row 820 for a given advertising campaign includes a “profiling criteria” field 830, an “ad timing and frequency” field 840, a “rate” field 850 and a “content” field 860. Of course, the advertising campaign database 130 need not be constructed as illustrated in FIG. 8. In particular, it should be understood that some fields may be omitted, while others may be added.

The “profiling criteria” field 830 indicates the profile of the subscribers that are being targeted by the given advertising campaign. This profile can be defined in terms of demographics and/or subscriber interests.

The “ad timing and frequency” field 840 indicates certain parameters regarding the advertising campaign, such as how long the advertising campaign will last, the timing of individual advertisements, limits on the maximum and/or minimum number of ads per subscriber per day, and so on.

The “rate” field 850 may include information on how the service provider is to be compensated by the advertiser, such as on a daily or per-advertisement basis, or based on the advertising campaign success (penetration) rate.

The “content” field 860 may identify a specific product or service to be advertised.

### Context Awareness Engine (CAE) 50

With further reference to FIG. 1, the CAE 50 has the functionality of a large, fast database that collects, processes and stores information relating to subscribers. The CAE 50 can communicate via a plurality of interfaces, including a third-party application API (application programming interface) 54 and a service provider network interface 56. The third-party application API 54 and the service provider network interface 56 can be hardware interfaces or software interfaces. Both interfaces are now described.

The service provider network interface 56 connects the CAE 50 to the service provider control network 114, which allows the CAE 50 to monitor information exchanged by the user devices 108. For example, the monitored information can include behavioural intelligence, demographic intelligence, transactional intelligence and Internet browsing activity, to name a few non-limiting possibilities. The monitored information can then be transformed into user data (e.g., demographics and subscriber interests) by engines such as subscriber data management (SDM), enterprise data warehouse (EDW), Neuralitics, etc. The user data (e.g., demographics and subscriber interests) are then stored in a subscriber interest database 52_{CAE} or other memory system. The user data (e.g., demographics and subscriber interests) can have any suitable degree of granularity (e.g., “sports” is less granular and “playoff hockey” is more granular”).

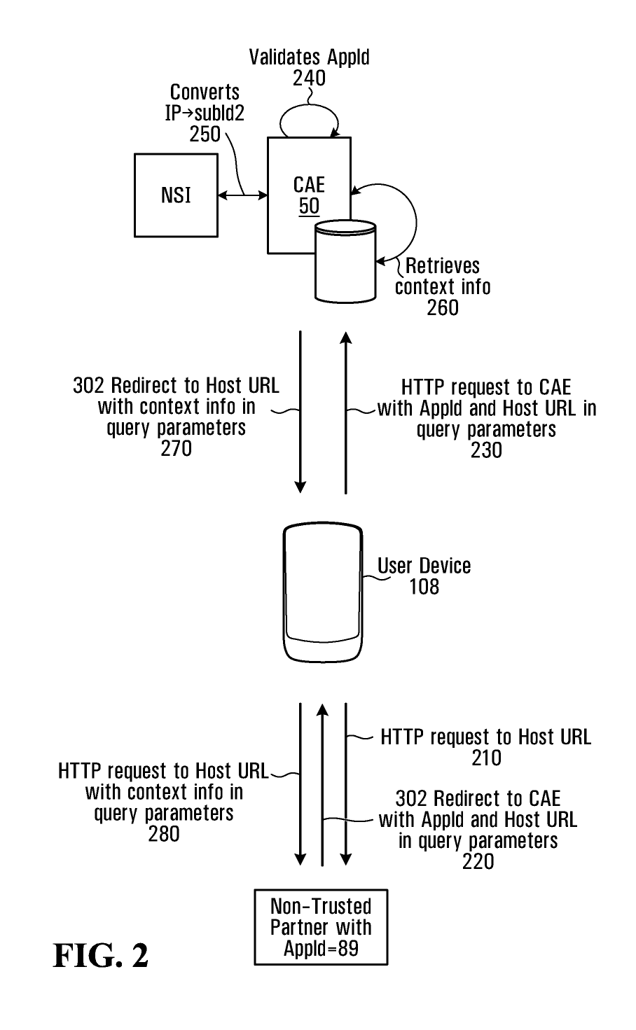

The third-party application API 54 serves to communicate with the targeted messaging system 40. The targeted messaging system 40 may issue queries to the CAE 50 via the third-party application API 54. Responses to those queries are delivered by the CAE 50 via the third-party application API 54. The third-party application API 54 can be a REST-like API implemented over http or https. Examples of the third-party application API 54 are provided below:
Partner API: Allows the CAE 50 to be queried in real time by a requesting entity (e.g., the targeted messaging system 40) and to supply a real-time response thereto. The partner API also allows the response to a real-time query to be placed in a file, such that the requesting entity can retrieve the results at a later time.
Batch API: Consists of pre-canned queries that may be configured in a graphical user interface (GUI) and run periodically. The results can be in the form of a CSV file which is placed into a TPA-specific directory, and the requesting entity can “pull” the resulting file from the CAE 50.
Pub/Sub API: Allows the requesting entity to be supplied with real-time notifications of changes to the data in the subscriber interest database 52_{CAE}.
Mobile API: Allows the requesting entity, which may be untrusted if associated with a non-home MNO, to be supplied with additional information on a subscriber without having to provide the identity of the subscriber. As such, it will be seen that a non-trusted requesting entity does not have to make any direct calls to CAE 50. It only has to perform an http 302 redirect and supply the attribute list that it wants returned. The call flow for achieving this is shown in FIG. 2, by way of non-limiting example:
   Firstly, an HTTP request is placed to the host URL;
   Next, an HTTP redirection (302 Redirect) to the Context Awareness Engine may be issued by the non-trusted entity, with the Appid (Application Identifier) and the Host URL (of the non-trusted entity) among the query parameters;
   Next, the user device makes an HTTP request to the Context Awareness Engine with the Appid and the Host URL in the query parameters;
   Next, the Context Awareness Engine validates the Appid, accesses the NSI in order to convert the IP address of the user device to the corresponding subscriber ID, and retrieves the context information for that subscriber;
   Next, the CAE issues an HTTP redirection (302 redirect) to the Host URL with the context information in the query parameters;
   Finally, the user device makes an HTTP request to the Host URL, with the context information in the query parameters.

By way of non-limiting example of communication between the targeted messaging system 40 and the CAE 50, the targeted messaging system 40 can provide the CAE 50 with a list of subscriber phone numbers, in addition to a list of demographics and subscriber interests. In response, the output of the CAE 50 can be a list of the subscribers whose demographics and subscriber interests match the supplied values. Thus, for example, the input to the CAE 50 may include:

Gender, Operator,
Prepaid/Post-paid

MSISDN1
MSISDN2
MSISDN3
MSISDN4
MSISDN5
MSISDN6
MSISDN7
MSISDN8

In response, the CAE 50 may produce an output that includes:

| | |
|---|---|
| MSISDN1, 15 | 20, F, Bell Mobility, Prepaid |
| MSISDN2, 20 | 25, M, Virgin, Prepaid |
| MSISDN3, 30 | 35, M, Bell Mobility, Prepaid |
| MSISDN4, 10 | 15, M, Virgin, Post-paid |
| MSISDN5, 25 | 30, F, Aliant, Post-paid |
| MSISDN6, 15 | 20, F, Bell Mobility, Prepaid |
| MSISDN7, 20 | 25, F, Solo, Prepaid |
| MSISDN8, 15 | 20, F, Bell Mobility, Prepaid |

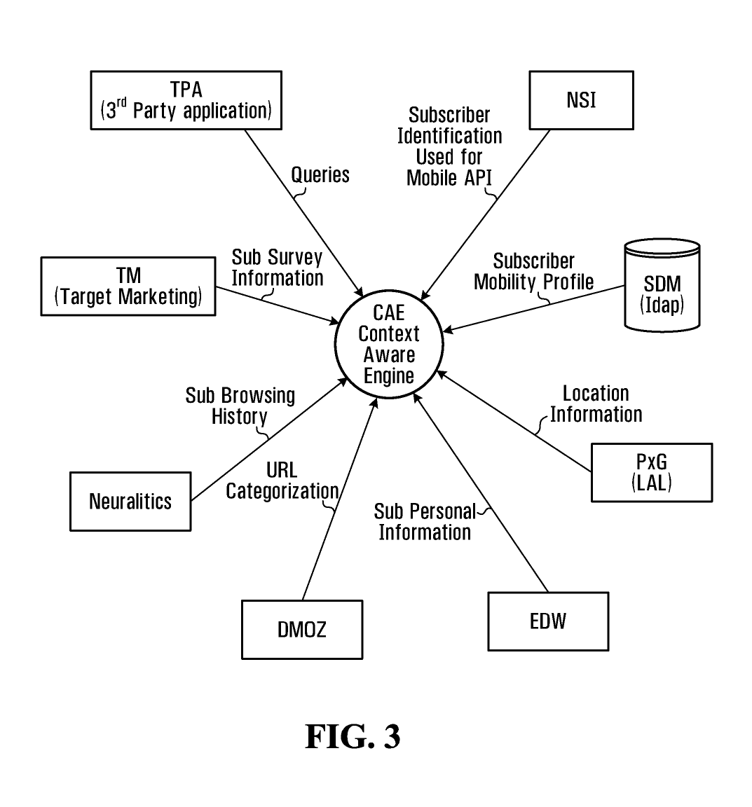

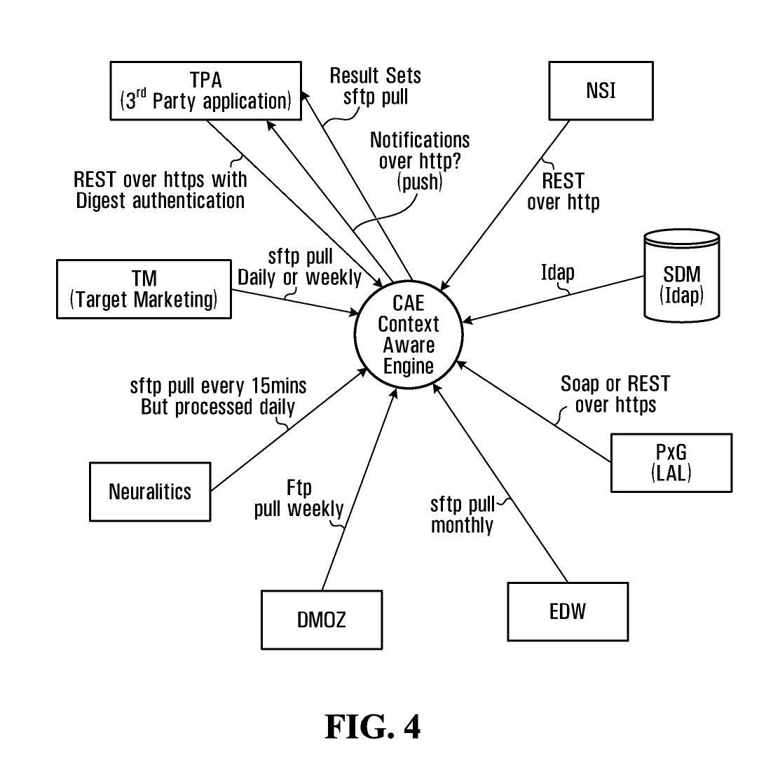

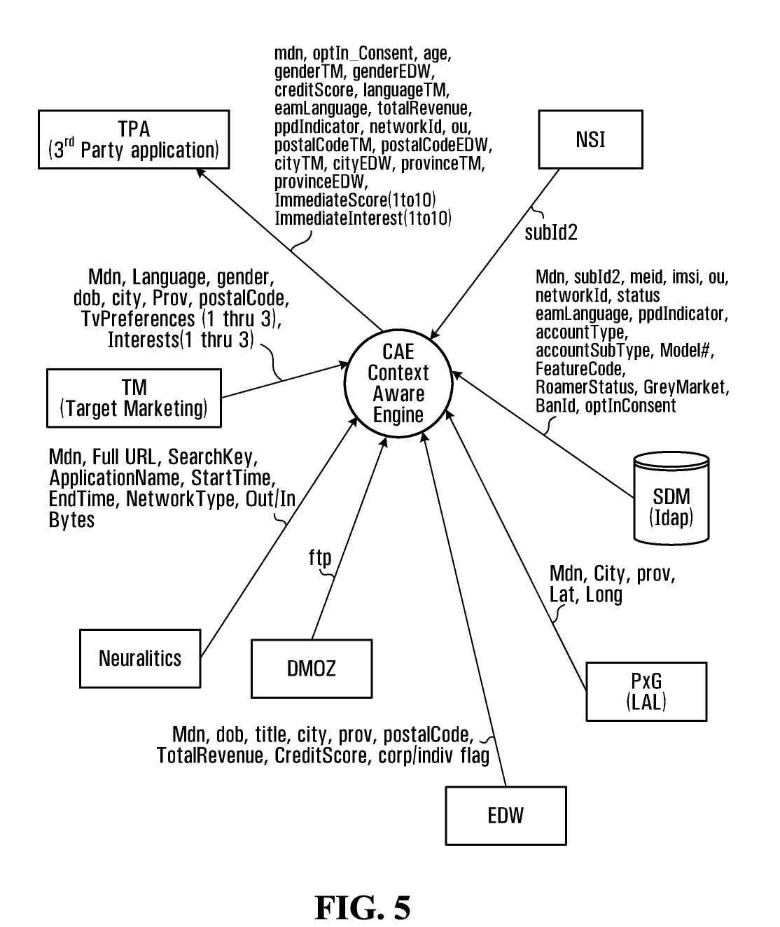

FIGS. 3-5 show additional functionality of the context awareness engine.

### Targeted Messaging System 40

In a specific non-limiting embodiment, the targeted messaging system 40 may comprise one or more computing devices (e.g., servers). For example, the one or more computing devices may execute computer-readable instructions that are tangibly stored on a computer-readable medium, such as a hard drive containing memory. Execution of the instructions may cause the one or more computing devices to implement one or more processes. By carrying out these one or more processes in the context of an advertising campaign, the targeted messaging system 40 makes decisions about the transmission of targeted messages to subscribers when conditions associated with the advertising campaign are satisfied.

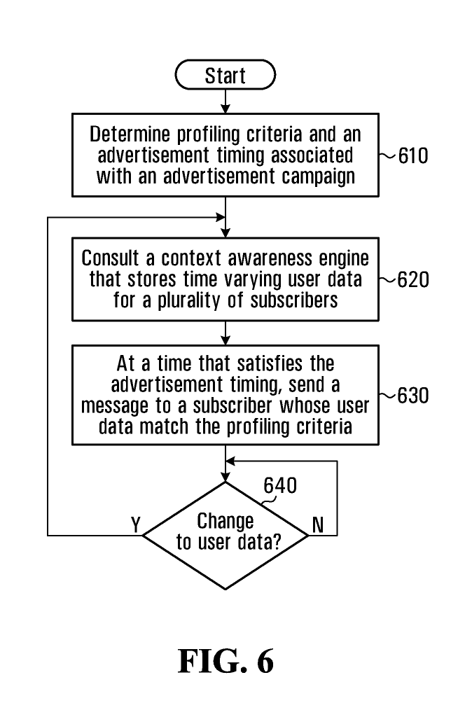

A non-limiting example of a process that may be carried out by the targeted messaging system 40 is now described in further detail with reference to the flowchart in FIG. 6, which includes steps 610 through 640 that can be executed by the targeted messaging system 40. It is assumed that an advertising campaign has been established for a particular advertiser and that the appropriate fields of the advertising campaign database 130 have been populated. At step 610, profiling criteria and an advertisement timing associated with an advertising campaign are determined. Then, at step 620, the targeted messaging system 40 consults the CAE 50 that stores time-varying user data (e.g., demographics and subscriber interests) for a plurality of subscribers. At a time that satisfies the advertisement timing, a message is sent to the subscriber if that subscriber's user data (e.g., demographics and subscriber interests) matches the profiling criteria (see step 630). This is done repeatedly (see step 640) as changes in the user data (e.g., demographics and subscriber interests) occur during the advertisement advertising campaign.

With continued reference to FIG. 1, the aforementioned process may be carried out by interoperation of a plurality of functional modules 48 and interfaces 60, 70 in the targeted messaging system 40. The functional modules 48 may be implemented as separate hardware devices. Alternatively, the functional modules 48 can correspond to individual processes associated with respective sets of computer-readable instructions executing separately on a shared machine. The functional modules 48 may include:
an Advertising Campaign Management functional module 48C;
an Opt-In functional module 48D;
a Data Gathering functional module 48E;
an Ad Delivery Manager functional module 48F;
a User Authentication functional module 48A; and
a Reporting and Invoicing functional module 48B.

The functional modules 48 interoperate with a plurality of interfaces 60, 70 located within a layered architecture of the targeted messaging system 40. The layers can include decoupled and firewall-separated front and back layers, referred to as a “data layer” 62 and a “web facing layer” 72. The data layer 62 may reside in a database management zone, while the web facing layer 72 may reside in a perimeter network (or DMZ). The perimeter network can be a physical or logical subnetwork that contains and exposes the service provider's external-facing services to an untrusted network, such as the Internet 104. The interfaces of the data layer 62 and the web facing layer 72, including a certain level of interoperation with the functional modules 48, are now described in further detail.

### Data Layer 62

The interfaces 60 of the data layer 62 communicate with a plurality of network elements, such as the SMSC 28, the MMSC 30 and the CAE 50. To this end, the data layer 62 implements an SMSC interface 60A, an MMSC interface 60B and a CAE interface 60C. In a non-limiting example of implementation, the protocol used by the SMSC interface 60A to integrate to the SMSC 28 can be SMPP, the protocol used by the MMSC interface 60B to integrate to the MMSC 30 can be MM7, while the format used by the CAE interface 60C to communicate with the CAE 50 can be a CSV file sent and received through SFTP. Each of the SMSC interface 60A, the MMSC interface 60B and the CAE interface 60C may comprise a functional entity that handles communication with the respective network element (not shown). The interfaces will now be described in greater detail.

The SMSC interface 60A can be used by the Opt-In functional module 48D. The Opt-In functional module 48D allows subscribers to opt-in to the targeted messaging service by entering a short code that can be used to track subscriber opt-in. The Opt-In functional module 48D also allows subscribers to opt-out of the targeted messaging service by entering a short code that can be used to track subscriber opt-out. For example, the short code may be received as text in the message field of a mobile-originated message indicating whether the subscriber wishes to opt in or opt out. If the subscriber chooses to opt in, an outcome could be a follow up mobile-terminated text message asking the subscriber to provide demographics and subscriber interests. These explicitly obtained demographics subscriber interests are stored in a subscriber interest database 52_{TMS}.

The SMSC interface 60A, as well as the MMSC interface 60B, can further be used by the Ad Delivery Manager functional module 48F as a delivery channel for advertisements. The Ad Delivery Manager functional module 48F regulates the delivery of advertisements to the end user. For example, in the case of a mobile-terminated message conveying an advertisement being delivered to the user device 108, the input to the Ad Delivery Manager functional module 48F could be the subscriber phone number that fits under the input criteria and the output could be an SMS or MMS delivery status report.

The CAE interface 60C can be used by the demographics and subscriber interests gathering functional module 48E to obtain additional demographics and subscriber interests that are not obtained by the Opt-In functional module 48D. Thusly, additional demographics and subscriber interests not provided during the subscriber opt-in process are extracted from the CAE 50 and can be used by advertisers to determine their “target subscriber base”. Specifically, the additional demographics and subscriber interests might be used for more effective targeting by advertisers.

The targeted messaging system 40 may support an architecture that provides the required flexibility to consume from additional data sources than those shown in FIG. 1. It may also provide the ability to obtain information from data services via a poll or a push mechanism. Protocols can include SSH, HTPPS, SOAP/XML over SSL, etc.

Also, the possibility exists that a data source may not explicitly expose an easy-to-use interface. Therefore, in some embodiments, the targeted messaging system 40 may provide an ability to retrieve the desired information in a manner that is specific/unique to the data source. This may involve pulling and parsing logs, or querying an external database.

### Web Facing Layer 72

Turning now to the web facing layer 72 in the perimeter network, this layer comprises several interfaces 70, including a advertising campaign management interface 70A, a Reporting and Invoicing interface 70B, an Opt-In/Opt-Out interface 70C and a Customer Service Representative (CSR) interface 70D.

The Advertising Campaign Management interface 70A can be used by the Advertising Campaign Management functional module 48C to allow advertising campaigns to be created, updated and managed by various individuals.

The Reporting and Invoicing interface 70B can be used by the Reporting and Invoicing functional module 48B to deliver reports.

The Opt-In/Opt-Out interface 70C can be used by the Opt-In functional module 48D to allow subscribers to opt into or out of the targeted messaging service over the Internet 104, and to provide demographics and subscriber interests that can be used for targeting.

The CSR interface 70D can be utilized by various functional modules in the targeted messaging system 40 to allow a home MNO super user or administrator to view the status of existing advertising campaigns and manually opt subscribers into or out of the targeted messaging service.

### Functional Modules 48

As mentioned above, the functional modules 48 interoperate with the interfaces 60, 70 to deliver the targeted messaging service offered by the service provider. A more detailed description of the functionalities provided by some of the functional modules 48 is provided herein below.

### User Authentication Functional Module 48A

The User Authentication functional module 48A may implement one or more of the following sub-functions.

(i) Super User Access

The User Authentication functional module 48A may be configured to allow a home MNO “super user” 76 (see FIG. 1) to create advertiser accounts. A home MNO super user 76 refers to a user with broad administrative access rights, beyond those of any subscriber or ordinary employee of the home MNO (service provider).

The User Authentication functional module 48A may also be configured to allow the home MNO super user 76 to manage the internal administrator and external advertiser accounts. Management of these accounts may include but need not be limited to password change, account suspension and account deletion.

In addition, the User Authentication functional module 48A may be configured to allow the home MNO super user 76 to control global system settings, which may include but need not be limited to: setting the number of simultaneous logins using different user accounts; setting the number of simultaneous logins using the same user account; setting the maximum number of messages sent to the end user per week; setting the maximum number of messages sent by each advertiser per week; setting the maximum TPS to the SMSC, the maximum TPS to the MMSC; setting the precedence for an Explicit Opt-In Database 185 versus the Do Not Disturb List 195 (see discussion of Opt-In Functional Module 48D below): setting the precedence for “profiling criteria” that are retrieved from various interfaces; setting control over the target subscriber base that is selected from an imported list; setting the interval and time for exporting the Explicit Opt-In Database 185; setting the interval and time for exporting subscriber profile information; setting the interval and time for importing the Do Not Disturb list; setting the interval and time for importing subscriber profile information, etc.

The User Authentication functional module 48A may be further configured to allow the home MNO super user 76 to view all reports, which may include but need not be limited to: individual advertising campaign reports; overall advertising campaign summary reports; overall opt-in reports; system access reports, overall system access reports; usage detail records; settlement reports; etc.

(ii) Home MNO Administrator Access

The User Authentication functional module 48A may be configured to allow a home MNO administrator 78 to manage the advertiser accounts. Management of these accounts may include but need not be limited to: rendering available the selection of certain “profiling criteria” by each advertiser; selection of reports that can be viewed by each advertiser; advertising campaign approval; password change; set and change email for approval notification; account suspension; account deletion; etc.

The User Authentication functional module 48A may also be configured to allow the home MNO administrator 78 to import a list of subscribers identified by their MSISDNs and set up an advertising campaign using the imported MSISDNs as the target subscriber base. This list may be either provided in any appropriate spreadsheet or database format, including, for example, CSV or EXCEL format.

In addition, the User Authentication functional module 48A may allow the home MNO administrator 78 to view all reports, which can include without being limited to individual advertising campaign reports; overall advertising campaign summary reports; overall opt-in reports; system access reports; overall system access reports; usage detail records; settlement reports; etc.

(iii) Advertiser Access

The User Authentication functional module 48A may be configured to allow the advertiser 42 to create a advertising campaign by identifying the following: selecting the profiling criteria; selecting the charging model; providing details on advertising campaign dialogue; selecting the channel for delivery (e.g., SMS, MMS, email, etc.); setting the start time/duration for advertising campaign; sending the advertising campaign for approval; etc.

The User Authentication functional module 48A may also be configured to allow the advertiser 42 to view certain reports, such as advertising campaign reports.

### Advertising Campaign Management Functional Module 48C

The targeted messaging system 40 allows an advertising campaign to be set up by the advertiser 42. Specifically, the advertiser 42 establishes “profiling criteria” as well as various parameters regarding the start and duration of the advertising campaign, the maximum frequency of messages, and so on. These are stored in the advertising campaign database 130.

The Advertising Campaign Management functional module 48C may implement one or more of the following sub-functions:

(i) Advertising Campaign Creation

The Advertising Campaign Management functional module 48C may be configured to provide an advertiser 42 or home MNO super user 76 or administrator 78 with the flexibility to set up a advertising campaign including a start and end time with one or more of the following characteristics: SMS dialogue; single SMS message; MMS dialogue; single MMS Message; etc.

The advertising campaign is directed to a target subscriber base.

In a non-limiting embodiment, the Advertising Campaign Management functional module 48C may be configured to allow the advertiser 42 or home MNO super user 76 or administrator 78 to select a subscriber base of a previously executed advertising campaign within its own domain (or a subset thereof) as the target subscriber base for the new advertising campaign.

In another non-limiting embodiment, the target subscriber base could be any of the following: subscribers that have clicked through an advertisement in the past; subscribers have provided demographics information; subscribers that have answered “YES” to a certain question ‘xyz?’; subscribers that have NOT clicked through an advertisement; subscribers have NOT provided demographics information; subscribers that have NOT answered “YES” to a certain question ‘xyz?’, all subscribers that have opted in to the targeted messaging service, etc., or any subset of the above.

In another non-limiting embodiment, the target subscriber base can be opted-in subscribers deemed to be potentially interested in the product or service being advertised. The set of subscribers in the target subscriber base can be determined by identifying those subscribers having a profile that matches certain profiling criteria selected by the advertiser 42 in accordance with its advertising campaign.

(ii) Profiling Criteria Selection

Below is an example list of criteria that could be selected as profiling criteria when determining the subscriber base for a particular advertising campaign:
Age
Age Range
Gender
City
Interest (various)
Top Domain
Partial URL
TV channel
Device OS
Device model
Device type (smart phone, feature phone)
Device manufacturer
Network type (HSPA, CDMA, LTE)
MVNO
ARPU
Location
Dial Plan (Prepaid/Post-paid)
Language

As will be shown later on when describing the Data Gathering functional module 48E, user data (e.g., demographics and subscriber interests) is obtained for the various subscribers and matched against the above profiling criteria. If there is a match for a given subscriber, the given subscriber is deemed to be potentially interested in the product or service being advertised. As such, the given subscriber will belong to the target subscriber base for the advertising campaign.

(iii) Charging Model

In some embodiments, the Advertising Campaign Management functional module 48C may be configured to provide a CPM (cost per thousand) and “cost per incremental profiling criterion” charging model. In other embodiments, a CPA (cost per action) and/or a “cost per click” charging model may also be made available. By way of non-limiting example, the following methods of charging may be available per block of, say, 1000 messages sent:

| Charging Model | Example |
|---|---|
| Per Profiling criterion | $1 for Age, $1 for Gender, $3 for Interests |
| Per # of Profiling criteria | $5 for Age, Gender and Interests |
| Per Message | $0.10 per message |
| Per # of Messages | $7 per 100 messages |
| Per Subscriber that | $0.10 per subscriber |
| matches profiling criteria | |
| Per Channel Used | $0.10 per SMS message |
| | $0.15 per MMS message |
| Per Successful Response | $1.00 per successful response |
| to Advertising campaign | |
| Per a Group of Successful | $50.00 for 100 successful responses |
| Responses to a | |
| Advertising campaign | |

(iv) Advertising Campaign Approval

In the case where the advertiser 42 is a non-trusted entity, the Advertising Campaign Management functional module 48C may be configured to present a advertising campaign summary and allow the user (e.g., a user who logs into the advertiser's account at the targeted messaging system) to verify the details of the advertising campaign prior to the user submitting it for moderation and approval. Once submitted for approval, the system can alert the home MNO administrator 78 via email that a request for approval has been submitted. The advertising campaign might be permitted to start only if approval is gained by the home MNO administrator 78.

In the case where the advertiser 42 is a trusted entity, the Advertising Campaign Management functional module 48C may be configured to present a advertising campaign summary and allow the user to verify the details of the advertising campaign. An approval might not be necessary for users that have been deemed as trusted advertisers if the targeted messaging system has determined that the defined advertising campaign does not exceed certain system and user thresholds.

### Opt-In Functional Module 48D

To address privacy concerns, the Opt-In Functional Module 48D can ensure that only subscribers who have opted in would receive relevant advertising. There can also be an option for the subscriber to opt out if they desire. An “opt-in status” of each subscriber can be maintained in the Explicit Opt-In Database 185, which is managed by the Opt-In Functional Module 48D.

For a subscriber who indicates an intention to opt in to the targeted messaging service, the opt-in status of that subscriber is marked as “opted in” in the Explicit Opt-In Database 185. The Opt-In Functional Module 48D may also provide the option for a subscriber to opt out of, or pause, the target messaging service. For a subscriber who indicates an intention to opt out of the targeted messaging service, the opt-in status of that subscriber is marked as “opted out” in the Explicit Opt-In Database 185. For a subscriber who indicates an intention to pause the targeted messaging service into which he/she has opted in, the opt-in status of that subscriber is marked as “paused” in the Explicit Opt-In Database 185.

Assuming the subscriber has opted in to the targeted messaging service, the subscriber creates an account with a password (delivered to him/her via web or SMS), logs in and provides demographics and subscriber interests related to his/her profile. These demographics and subscriber interests could include age, age range, gender, city, interest, TV channels of interest, device operating system, device model, device type (smart phone, feature phone, tablet), device manufacturer, network type (HSPA, CDMA, LTE), location, subscription plan (prepaid/post-paid), language, interests, etc. The demographics and subscriber interests may be supplied explicitly by user input or autonomously. The opt-in/pause/opt-out web interface sub-function stores the collected demographics and subscriber interests into the subscriber interest database 52_{TMS}. Upon a pause of service, the demographics and subscriber interests for a particular subscriber may continue to be stored in the event that the subscriber decides to resume the target messaging service.

In view of the above, the Opt-In Functional Module 48D may implement the following sub-functions:

(i) Opt-In/Pause/Opt-Out Web Interface

The Opt-In/Pause/Opt-Out Web Interface sub-function may be allow the home MNO subscriber to opt in, opt out or pause the targeted messaging service via the opt-in/opt-out interface 70C in the web facing layer 72.

(ii) Opt-In/Pause/Opt-Out SMS Dialogue

The Opt-In/Pause/Opt-Out SMS Dialogue sub-function may allow for subscribers to opt in, opt out or pause the targeted messaging service via an SMS short code.

(iii) Do Not Disturb List Management

The Do Not Disturb List Management sub-function may ingest a list of subscribers, referred to as the “Do Not Disturb List” 195, from a home MNO network element (not shown) at a scheduled time interval or at an arbitrary time instant. The Do Not Disturb List 195 may contain a list of subscribers that have opted out of receiving advertising through alternative home MNO processes (i.e., they may have generally opted out of any advertising whatsoever). The subscribers identified in the Do Not Disturb List 195 can be used in conjunction with the opt-in status of the subscribers of the Explicit Opt-In Database 185 in order to gain a complete picture of the “opted-in subscriber base”, i.e., the set of subscribers who have opted in to the targeted messaging service, and which is further narrowed to obtain the target subscriber base for the advertising campaign.

The Do Not Disturb List Management function may allow the home MNO super user 76 or administrator 78 to specify which list takes precedence when the same subscriber identifier appears in both lists. In other words, a decision is made by the home MNO super user 76 or administrator 78 as to which of the Do Not Disturb List 195 and the Explicit Opt-In Database 185 has higher precedence. When a subscriber that appears on both lists is encountered and it is desired to determine whether the subscriber forms part of the opted-in subscriber base, the Do Not Disturb List Management sub-function may first determine which of the two lists will take precedence.

If the Do Not Disturb List 195 has been configured to take precedence over the Explicit Opt-In Database 185, the Do Not Disturb List Management sub-function may cross-reference the Explicit Opt-In Database 185 to the Do Not Disturb List 195 and remove from the preliminary version of the opted-in subscriber base those numbers from Do Not Disturb List 195 that also belong to the Explicit Opt-In Database 185. In this case, if a subscriber belonging to the Do Not Disturb List 195 explicitly opts in to the targeted messaging service using the Opt-In/Pause/Opt-Out SMS Dialogue sub-function, the subscriber may continue to be added to the Explicit Opt-In Database 185; however, the targeted messaging system need not respond to the SMS message. Similarly, if a subscriber belonging to the Do Not Disturb List 195 explicitly opts in to the targeted messaging service using the opt-in/pause/opt-out web interface sub-function, the subscriber can be added to the Explicit Opt-In Database 185; however, he/she need not be included in the opted-in subscriber base until a future change where the Explicit Opt-In Database 185 takes precedence over the Do Not Disturb List 195. In this case, the opt-in/pause/opt-out web interface sub-function may provide the subscriber with a message informing him/her that he/she is on the Do Not Disturb List 195 and guiding him/her as to the process he/she should follow to remove him/her from the Do Not Disturb List 195.

If, on the other hand, the Explicit Opt-In Database 185 has been configured to take precedence over the Do Not Disturb List 195, the Do Not Disturb List Management sub-function may use the Explicit Opt-In Database 185 as the preliminary version of the opted-in subscriber base. In this case, if a subscriber belonging to the Do Not Disturb List 195 explicitly opts in to the targeted messaging service using the Opt-In/Pause/Opt-Out SMS Dialogue sub-function, the subscriber may continue to be added to the Explicit Opt-In Database 185 and the targeted messaging system should respond to the SMS message. Additionally, if a particular subscriber belonging to the Do Not Disturb List 195 explicitly opts in to the targeted messaging service using the opt-in/pause/opt-out web interface sub-function, the details provided may continue to be stored on the targeted messaging system and the particular subscriber may be added to the Explicit Opt-In Database 185. The particular subscriber is thus also included in the opted-in subscriber base.

### Data Gathering Functional Module 48E

During the advertising campaign, user data (e.g., demographics and subscriber interests) is gathered for the various subscribers in the opted-in subscriber base. The gathered data is matched against the profiling criteria in the advertising campaign database 130. If there is a match for a given subscriber, the given subscriber is deemed to be in the target subscriber base for the advertising campaign. Then, the Ad Delivery Manager functional module 48F (described later on in further detail) takes over regarding the timing, transmission and content of an ad directed to the given subscriber. Note that the target subscriber base will tend to be a subset of the opted-in subscriber base.

In some cases, the user data (e.g., demographics and subscriber interests) that is compared against the profiling criteria can be obtained from either or both of the subscriber interests database 52_{TMS} (which is populated based on information received explicitly from the subscriber through interaction with the opt-in functional module 48D) and the subscriber interests database 52_{CAE} (which is populated by the CAE 50 based on monitored information, such as Internet browsing activity). Below is a table showing the provenance of various user data (e.g., demographics and subscriber interests) that may be compared against profiling criteria:

| | Corresponding user | Corresponding user |
|---|---|---|
| | data available in | data available in |
| | subscriber interests | subscriber interests |
| Possible profiling criteria | database 52_{CAE}? | database 52T_{TMS}? |
| Age | Yes | Yes |
| Age Range | Yes | Yes |
| Gender | Yes | Yes |
| City | Yes | Yes |
| Interest (various) | Yes | Yes |
| Top Domain | Yes | No |
| Partial URL | Yes | No |
| TV channel | Yes | Yes |
| Device OS | Yes | No |
| Device model | Yes | No |
| Device type (smart phone, | Yes | No |
| feature phone) | | |
| Device manufacturer | Yes | No |
| Network type (HSPA, | Yes | No |
| CDMA, LTE) | | |
| MVNO | Yes | No |
| ARPU | Yes | No |
| Location | Yes | Yes |
| Dial Plan (Prepaid/Post- | Yes | No |
| paid) | | |
| Language | Yes | Yes |

In the event that user data exists in both the subscriber interests database 52_{CAE} and the subscriber interests database 52_{TMS}, the home MNO super user 76 or administrator 78 may be able to specify which user data takes precedence, on a per advertiser basis. Below is an example of user data that could be gathered both explicitly through the opt-in functional module 48D (therefore stored in the subscriber interests database 52_{TMS}) and implicitly through the CAE 50 (therefore stored in the subscriber interests database 52_{CAE}), with example preference settings for one advertiser.

| User Data | What Takes Precedence? |
|---|---|
| Age | Opt-In Functional module |
| Age Range | Home MNO Network Element |
| Birthday (dd,mm,yy) | Opt-In Functional module |
| Gender | Opt-In Functional module |
| City | Opt-In Functional module |
| Interests | Home MNO Network Element (e.g., |
| | CAE) |
| TV channel | Opt-In Functional module |
| Location | Opt-In Functional module |
| Language | Opt-In Functional module |

Other user data may only be available from the subscriber interests database 52_{CAE}, which may be the case with certain demographics and subscriber interests that are determined by the CAE 50 based on monitored information such as Internet browsing activity. Examples of such user data include a particular domain name (e.g., www.abc.com) or full URL (e.g., http://www.cbssports.com/nfl/superbowl).

To determine the target subscriber base for the advertising campaign, the Data Gathering functional module 48E gathers the user data (e.g., demographics and subscriber interests) for the various subscribers in the opted-in subscriber base. The gathered data is matched against the profiling criteria in the advertising campaign database 130. If there is a match for a given subscriber, the given subscriber is deemed to be in the target subscriber base for the advertising campaign.

When “Domain Name” or “Full URL” have been selected as profiling criteria for selecting the target subscriber base, a message may be presented to the advertiser 42 informing them that the operation cannot happen in real time as some backend processing needs to occur. Meanwhile, the Data Gathering functional module 48E can send the list of subscribers to the CAE 50 with the domain name or full URL of interest. The CAE 50 may return a subset of the original list back to the targeted messaging system 40 which can include the subscribers that have accessed the domain name or full URL of interest. The list returned by the CAE can then be used as the target subscriber base.

The advertiser 42 might be able to continue with processing the advertising campaign while the target subscriber base is assembled in the background based on information from the CAE 50. If the advertising campaign is submitted prior to the full knowledge of the target subscriber base, the advertiser 42 may be presented with a prompt asking them to confirm that they are willing to proceed. Their acceptance can capture the advertiser's agreement which can be used in a settlement process with the advertiser 42.

### Ad Delivery Manager Functional Module 48F

For a given advertising campaign, the Ad Delivery Manager functional module 48F delivers suitable advertising campaign messages (e.g., advertisements) to the target subscriber base identified above, at a suitable time. The nature of the message and its timing are specified in the advertising campaign database 130.

Ads can be delivered via a variety of pathways, such as via SMS or MMS, or alternatively via email, social networking or another communication medium. The Ad Delivery Manager functional module 48F has access to the subscriber database 120, which provides it with information on the addresses, phone numbers and other contact information for reaching the subscribers.

The Ad Delivery Manager functional module 48F may also cause message delivery to occur within a predefined desired time period, taking into consideration various time zones.

The Ad Delivery Manager functional module 48F may also provide a mechanism for the home MNO super user 76 or administrator 78 to specify the acceptable SMS/MMS delivery time frame per subscriber NPA (numbering plan area). Upon the execution of a advertising campaign this can be referenced to determine the appropriate time for SMS/MMS delivery to the end user.

Also, the Ad Delivery Manager functional module 48F may provide a mechanism for the home MNO super user 76 or administrator 78 to limit the number of messages received per subscriber per time unit (e.g., per week) and/or the number of messages sent by each advertiser per time unit (e.g., per week).

Additionally, the Ad Delivery Manager functional module 48F may provide a retry mechanism for attempting re-transmission of the SMS, MMS, email or social networking message upon a failure response or a timeout. The timeout, failure error codes, retry frequency and retry interval may be configurable by the home MNO super user 76 or administrator 78. The retry mechanism may be configurable based on failure error codes.

### Reporting and Invoicing Functional Module 48B

The Reporting and Invoicing functional module 48B may implement one or more of the following sub-functions.

(i) Monitoring Advertising Campaign Progress

The Reporting and Invoicing functional module 48B may be configured to track various metrics while the advertising campaign is being executed. Non-limiting metrics may include the number of messages sent; the number of messages delivered; the number of messages scheduled to be retried; the number of messages that received a response of x (where x could be any one of the response options presented to the subscriber); the number of messages that did not receive a response; etc.

(ii) Individual Advertising Campaign Reports

The Reporting and Invoicing functional module 48B may be configured to make individual advertising campaign reports available for home MNO administrators and advertisers with a variety of details, which may include the name of the advertiser; the charging model selected; the advertising campaign id; the advertising campaign creation date; the advertising campaign approval date; the profiling criteria selected; the total number of addressable base; the advertising campaign duration; the total number of messages sent; the total number of messages delivered; the total number of messages that received a response; the total number of messages that received a positive response (i.e., generated a ad click through, opted in, provided personal profile information, answered positive to a question asked, etc.); the total number of messages that received a negative response (i.e., generated a ad click through, opted in, did not provide personal profile information, answered positive to a question asked, etc.)

(iii) Overall Advertising Campaign Summary Reports

The Reporting and Invoicing functional module 48B may be configured to make overall advertising campaign summary reports available for home MNO administrators and advertisers with details such as the number of advertising campaigns created per advertiser; the number of advertising campaigns executed per advertiser; the average duration of advertising campaigns per advertiser; the average response rate of advertising campaigns per advertiser; the total number of advertising campaigns created; the total number of advertising campaigns executed; the overall average duration of advertising campaigns; the overall average response rate of advertising campaigns; the overall opt-in reports; etc.

The Reporting and Invoicing functional module 48B may also make overall opt-in reports available for home MNO administrators and advertisers with details such as: total overall number of opt-in subscribers (through the opt-in functional module 48D); total number of subscribers providing profile data (through the opt-in functional module 48D); etc.

(viii) Exporting Opt-In Database

The Reporting and Invoicing functional module 48B may be configured to allow the export a list of subscribers that have opted in to the service, either through a web interface or at a configurable time interval to a home MNO network element. By way of non-limiting example, the list can be provided in a CSV file stored in an opt-in database 78 (see FIG. 1). The format of the file can be provided during the design phase.

Other sub-functions that may be implemented by the Reporting and Invoicing functional module 48B include:
Overall Opt-In Reports;
System Access Reports;
Usage Detail Reports;
Settlement Reporting;
Exporting Personal Profile Data; and
Importing Subscriber Profile Information.

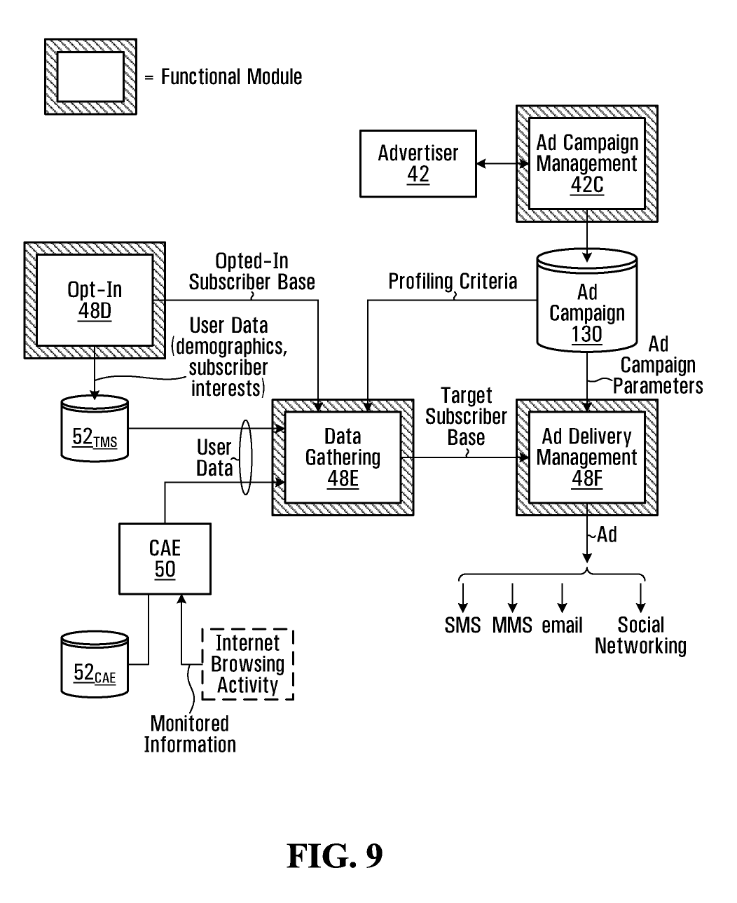

Thus, as will be appreciated, the targeted messaging system 40 may draw upon the value-add of time-varying user data (e.g., demographics and subscriber interests) for more effective subscriber targeting. With reference to FIG. 9, the Data Gathering functional module 48E compares the time-varying user data against profiling data previously specified by the advertiser 42 (when interacting with Advertising Campaign Management functional module 48C during setup of the advertising campaign). The profiling criteria may include specific demographics or interests, which can include top domains or URLs accessed by the target subscriber base through their mobile browsers. Some of the time-varying user data is obtained from the subscriber interest database 52_{TMS}. Such user data includes user data obtained from the subscriber (e.g., during an opt-in process carried out with the opt-in functional module 48D). Other user data is obtained from the subscriber interest database 52_{CAE} by having the Data Gathering functional module 48E query the CAE 50. Such user data (e.g., top domains or URLs) may be derived from monitored information such as Internet browsing activity. When there is a match between the user data for a particular subscriber and the profiling criteria for a particular advertising campaign, the particular subscriber is said to belong to the target subscriber base for the particular advertising campaign. Then, at a suitable time that may be set by the advertiser 42, a message is sent to the subscribers in the target subscriber base by the Ad Delivery Manager functional module 48F.

### Use Cases

In operation, the aforementioned functional modules 48 of the targeted messaging system cooperate to enable various use cases, two of which are described below.

Subscriber Use Case
1. A subscriber using user device 108 opts in to the targeted messaging service. The opt-in could be via different channels (e.g., SMS dialogue or via the Internet);
2. The target messaging system 40 launches an SMS dialogue advertising campaign with the subscriber to explicitly receive his/her demographics and subscriber interests. The provided information is stored in the demographics and subscriber interests database 52, and can eventually be compared against profiling criteria specified by the advertiser 42 for a particular advertising campaign in order to evaluate suitability of the subscriber with respect to that advertising campaign;
3. The subscriber receives targeted messages from the targeted messaging system 40. These could be received via SMS, MMS, or at an email account or social networking account for the subscriber.
4. The subscriber could opt-out or pause their targeted messaging service.

### Advertiser Use Case

1. Home MNO super user 76 creates an account for home MNO administrators and advertisers;
2. Advertiser 42 registers with the User Authentication functional module 48A;
3. Advertiser 42 selects from a number of profiling criteria to determine the target base (e.g., male from 18 to 25 with interests in sports) through the Advertising Campaign Management functional module 48C;
4. Advertiser 42 selects the advertising campaign delivery channel (e.g., SMS, MMS, email, social networking, etc.) through the Advertising Campaign Management functional module 48C;
5. Advertiser 42 views the cost of targeting the target subscriber base with the delivery channel chosen through the Advertising Campaign Management functional module 48C;
6. Advertiser 42 sets up the advertising campaign message and the preferred time for execution of advertising campaign through the Advertising Campaign Management functional module 48C and submits the advertising campaign;
7. A home MNO administrator receives a notification requesting their approval of the advertising campaign if the advertiser 42 is configured as untrusted, and the home MNO administrator can choose to approve or deny the advertising campaign. Otherwise, if the advertiser 42 is configured as trusted, the advertising campaign can be automatically executed at the desired time interval if it does not exceed system and user thresholds;
8. The targeted messaging system 40 sends messages during the advertising campaign interval. These messages can be sent through the SMSC 28 or the MMSC 30, via email or a social networking platform.
9. The targeted messaging system 40 tracks appropriate metrics (delivered, response rate, etc) in the Reporting and Invoicing functional module 48B and allows an administrator to view such metrics;
10. The targeted messaging system 40 tracks appropriate metrics for the purposes of reconciliation and billing and allows an administrator to view such metrics through the Reporting and Invoicing functional module 48B.

In some embodiments, at least one aspect of the invention may be implemented on a programmed computing apparatus, such as a computing apparatus that comprises an I/O, a memory and a processing engine. The processing engine may execute computer-readable instructions stored in the memory to implement a method, which may involve interacting with a network, such as the Internet, via the I/O (interface).

In some cases, the implemented method may involve interacting with a user via the I/O such as by causing the display of images or the playback of sounds via an output device (display, loudspeaker), or the receipt and processing of inputs entered via an input device (e.g., keyboard, touch screen, mouse, speech processor/recognizer).

The computer-readable program code or instructions could be stored on a medium which is fixed, tangible and readable directly by the one or more computing apparatuses, (e.g., removable diskette, CD-ROM, ROM, fixed disk, USB drive), or the computer-readable program code could be stored remotely but transmittable to the one or more computing apparatuses via a modem or other interface device (e.g., a communications adapter) connected to a network (including, without limitation, the Internet) over a transmission medium, which may be either a non-wireless medium (e.g., optical or analog communications lines) or a wireless medium (e.g., microwave, infrared or other transmission schemes) or a combination thereof.

In other embodiments, the may be implemented using pre-programmed hardware or firmware elements (e.g., application specific integrated circuits (ASICs), electrically erasable programmable read-only memories (EEPROMs), flash memory, etc.), or other related components.

In the examples described above, the device, elements are connected to each other as shown in the figures, for the sake of simplicity. In practical applications of the present invention, elements, circuits, etc. may be connected directly to each other. As well, elements, circuits etc. may be connected indirectly to each other through other elements, circuits, etc., necessary for operation of the devices or apparatus. Thus, in actual configuration, the devices, elements and circuits are directly or indirectly coupled with or connected to each other.

Certain adaptations and modifications of the described embodiments can be made. Therefore, the above discussed embodiments are to be considered illustrative and not restrictive. Also it should be appreciated that additional elements that may be needed for operation of certain embodiments of the present invention have not been described or illustrated as they are assumed to be within the purview of the person of ordinary skill in the art. Moreover, certain embodiments of the present invention may be free of, may lack and/or may function without any element that is not specifically disclosed herein.

What is claimed is:

1. A method for execution by at least one network element of a service provider, comprising:
a) determining profiling criteria and an advertisement timing associated with an advertising campaign;
b) consulting a context awareness engine that stores time-varying user data for a plurality of subscribers;
c) at a time that satisfies the advertisement timing, sending a message to a subscriber whose user data match the profiling criteria; and
d) repeating steps b) and c) after a change in the user data has occurred during the advertising campaign.

2. The method defined in claim 1, wherein consulting a context awareness engine comprises, for a given subscriber:
identifying the given subscriber to the context awareness engine;
receiving from the context awareness engine the user data associated with the given subscriber; and
comparing the user data to the profiling criteria.

3. The method defined in claim 2, wherein the steps of identifying, receiving and comparing are repeated for each of the subscribers in the plurality of subscribers.

4. The method defined in claim 1, wherein consulting a context awareness engine comprises, for a given subscriber:
identifying the given subscriber and the profiling criteria to the context awareness engine; and
receiving an indication of whether the user data stored for the given subscriber in the context awareness engine match the profiling criteria.

5. The method defined in claim 4, wherein the steps of identifying and receiving are repeated for each of the subscribers in the plurality of subscribers.

6. The method defined in claim 1, further comprising, prior to consulting the context awareness engine:
consulting an opt-in database to identify a set of subscribers that have opted in to receive targeted messages;
wherein sending a message to a subscriber is only performed if the subscriber is in the set of subscribers that have opted in to receive targeted messages.

7. The method defined in claim 6, wherein consulting a context awareness engine comprises:
identifying the set of subscribers to the context awareness engine;
receiving from the context awareness engine the user data associated with each of the subscribers in the set of subscribers; and
comparing the user data to the profiling criteria.

8. The method defined in claim 6, wherein consulting a context awareness engine comprises:
identifying the set of subscribers and the profiling criteria to the context awareness engine; and
receiving a list of subscribers whose user data stored in the context awareness engine match the profiling criteria.

9. The method defined in claim 1, wherein sending the message to the subscriber comprises sending an SMS message to the subscriber.

10. The method defined in claim 1, wherein sending the message to the subscriber comprises sending an MMS message to the subscriber.

11. The method defined in claim 1, wherein sending the message to the subscriber comprises sending an email to the subscriber.

12. The method defined in claim 1, wherein sending the message to the subscriber comprises sending a message to the subscriber via a social network.

13. The method defined in claim 1, wherein consulting the context awareness engine is done via a service provider network interface.

14. The method defined in claim 1, wherein consulting the context awareness engine is done via an API.

15. The method defined in claim 1, further comprising, prior to consulting the context awareness engine:
consulting a Do Not Disturb database to identify a set of subscribers that have requested to not receive targeted messages; and
wherein sending a message to a subscriber is not performed if the subscriber is in the set of subscribers that have requested to not receive targeted messages.

16. The method defined in claim 1, further comprising, prior to consulting the context awareness engine:
consulting an opt-in database to identify a set of subscribers that have opted in to receive targeted messages; and
consulting a Do Not Disturb database to identify a set of subscribers that have requested to not receive targeted messages;

17. The method defined in claim 16, further comprising, if a subscriber is identified in both the set of subscribers that have opted in to receive targeted messages and in the set of subscribers that have requested to not receive targeted messages:
a) consulting at least one of the at least one network element of the service provider to determine which of the opt-in database and the Do Not Disturb database is treated with higher precedence; and
b) based on the precedence, determining whether to send a message to the subscriber whose user data match the profiling criteria.

18. The method defined in claim 1, wherein the user data comprises information relating to at least one of age, age range, birthday, gender, current location, city and language of the user.

19. The method defined in claim 1, wherein the user data comprises information relating to interests of the user.

20. A computing apparatus comprising an I/O, a memory and a processing engine, the processing engine executing computer-readable instructions stored in the memory for:
a) determining profiling criteria and an advertisement timing associated with an advertising campaign;
b) consulting a context awareness engine that stores time-varying user data for a plurality of subscribers;
c) at a time that satisfies the advertisement timing, sending a message to a subscriber whose user data match the profiling criteria; and
d) repeating steps b) and c) after a change in the user data has occurred during the advertising campaign.

21. Non-transitory computer-readable medium comprising computer-readable instructions which, when executed by a computing hardware, cause the computing hardware to execute a method that comprises:
a) determining profiling criteria and an advertisement timing associated with an advertising campaign;
b) consulting a context awareness engine that stores time-varying user data for a plurality of subscribers;
c) at a time that satisfies the advertisement timing, sending a message to a subscriber whose user data match the profiling criteria; and
d) repeating steps b) and c) after a change in the user data has occurred during the advertising campaign.

22. A method, comprising:
providing a telecommunications service to a plurality of subscribers;
querying a context awareness engine to identify a subset of the subscribers having opted in to a targeted promotional messaging service; and
sending a targeted promotional message to the subscribers in the subset to promote a product or service and refraining from sending the targeted promotional message to those subscribers who are not in the subset.
